(19) United States
(12) Patent Application Publication
(10) Pub. No.: US 2007/0098981 A1
(43) Pub. Date: May 3, 2007

(54) Protective sheets for hands or shoes

(76) Inventor: James V. Guffey, Cape Coral, FL (US)

Correspondence Address: James V. Guffey, 6368 Emerald Pines Circle, Fort Myers, FL, 33912, US

(21) Appl. No.: 11/263,446

(22) Filed: Nov. 1, 2005

(51) Int. Cl. B32B 7/12

(52) U.S. Cl. 428/352; 428/354

(57) ABSTRACT

A multiple of protective sheets are supplied in a stack. There is a main layer that will ultimately form the protective sheet. The main sheet has an upper surface having an adhesive surface thereon. The upper surface will adhere to any item that is pressed thereon. The lower surface of the main layer has a release agent thereon that has less of an adhesive power than the upper layer. The reason for this is that when the item that is pressed on the upper surface it will adhere to that item but will be released from the next lower protective sheet in the stack. The lower surface release agent, however is strong enough to keep the remainder of the stack intact but will “let go” when the protective sheet is peeled from the next lower sheet. The stack of protective sheets can be configured either as a hand or the outline of a shoe.

### BACKGROUND OF THE INVENTION

Protective sheets are used in all kinds of situations to protect against bacteria or contamination such as dirt left behind by unclean hands and or shoes. In a self-service gas station, for example, many users of the gas nozzle leave behind dirt accumulations and/or bacteria that are undesirable for a user. Also, when filling a gas tank of an automobile, the hands invariably smell of gasoline. Workmen frequently have to enter a home for repairs or adjustments to equipment and unless they take their shoes off or wear clean overshoes the floors including the carpet will be soiled. It is known in grocery stores that clean wipies are available at the entrance to the store to wipe the handle of the grocery cart to remove any kind of residue left by a prior user. To avoid all of the above, people carry rags on the person or use gloves to avoid contact with any kind of equipment. Deli-counter workers are known and required to wear plastic gloves to avoid any hand contact with uncovered food stuff.

U.S. Pat. No. 3,056,154 offers a description of a hand enveloping glove being supplied in a stack with one side having a tacky surface while the other side will removably adhere-to the next lower glove in a stack of gloves. This is considered to be the closest prior art when compared to the inventive sheet protective device which involves individual sheets and not hand enveloping gloves.

U.S. Pat. No. 3,903,620 illustrates a clean sole attachment of a single sheet that is adhesively fastened to an underside of a shoe. Prior to any use of the protective sheet, a peel sheet must be manually removed to expose the adhesive surface which then is applied to the bottom of the shoe.

U.S. Pat. No. 5,956,770 discloses a glove with attachable cleaning pads that are adapted for removable coupling with a front surface of the glove. Each of the pads have a colored outer surface that is different from one another. Each of the cleaning pads have a different cleaning purpose.

U.S. Pat. No. 6,178,554 shows a single sheet that covers the palm of the hand which sheet has at one end thereof an opening through which a hand is inserted to thereby keep the sheet in the vicinity of the hand and on the palm.

U.S. Pat. No. 6,360,373 discloses a glove consisting of an inner hand enveloping glove that is in a contaminant condition and has outer sheets that may be peeled away prior to the use of the inner glove to expose the contaminant-free surface.

U.S. Pat. No. 6,604,244 illustrates a work glove that has a plurality of removable pads adhered to the digits and the palm of the user.

U.S. Pat. No. 6,637,035 shows disposable gloves that envelope the hand of a user and that are mass produced in sheet forms.

U.S. Pat. No. 6,684,442 teaches a method of preparing shoe protective sheets that can be attached to a sole of a shoe by first removing or peeling off a protective cover from an adhesive surface that will adhere to an underside or the sole of a shoe.

### BRIEF DESCRIPTION OF THE INVENTION

All of the above enumerated instances, when in use, are quite cumbersome and not always available. Plastic gloves, while sanitary, are not comfortable to wear for any extended period of time, and depending on the individual, because of induced sweating of the skin because of the non-breathing material. The inventive concept is directed to a single sheet of plastic material that may be obtained from a stack of protective sheets by merely pressing a hand or a shoe to the top surface of the top sheet of the stack.

### BRIEF DESCRIPTION OF THE INVENTION

The protective sheet or guard for a palm of a hand or a sole of a shoe consists of a single plastic sheet which has an upper surface pressure sensitive adhesive which will adhere to the skin of a human palm or the lower sole of a shoe when pressed thereon. The lower surface of the protective sheet has a release agent applied thereto so that it can easily be peeled away from the pressure sensitive adhesive on the upper surface of the next lower sheet. The reason for the release agent is that a multiple of protective sheets are provided in a stack and the release agent gives some adherence that will hold the stack together. When the palm of a hand or the bottom of a shoe is pressed onto the top layer, the top layer will readily adhere to the palm or the shoe bottom but will easily release itself from the next lower layer without disturbing the remainder of the stack.

### BRIEF DESCRIPTION OF THE DRAWINGS

FIG. 1 illustrates a stack of protective sheets adhering to each other;

FIG. 2 shows a protective sheet as it is adhered to a palm of a hand;

FIG. 3 illustrates a finger with a protective sheet thereon about to be released from the next lower sheet;

FIG. 4 shows a protective sheet as it is adhered to a bottom of a shoe;

FIG. 5 shows a method of die cutting a stack of protective sheets.

### DETAILED DESCRIPTION OF THE INVENTION

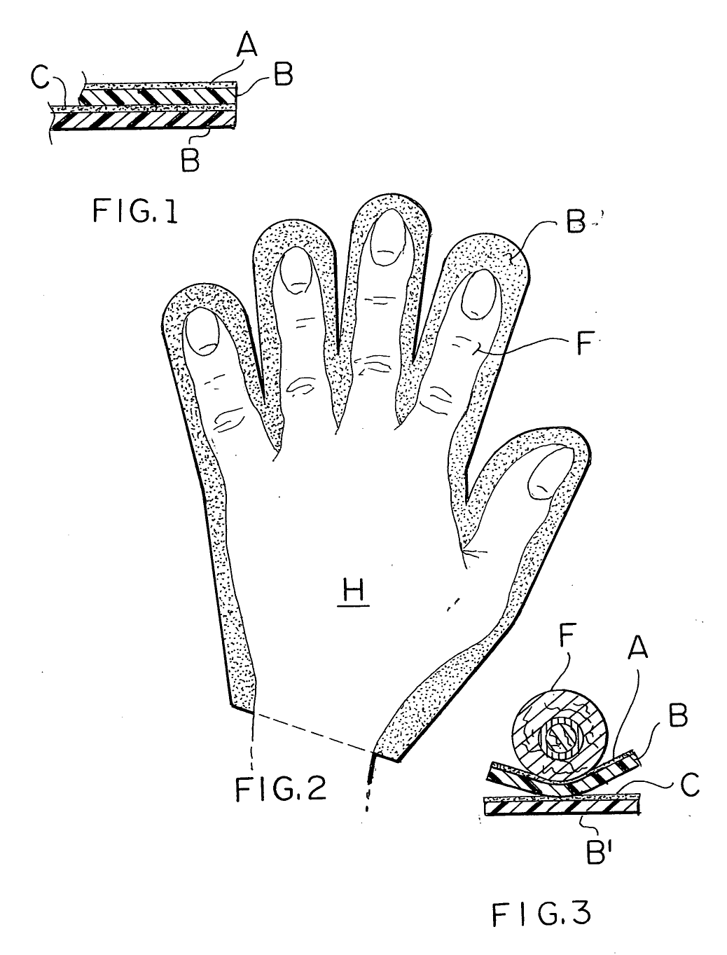

FIG. 1 shows a stack of some of the protective sheets in a ready to use manner. The basic protective sheet is shown at B. It has a top layer A of an adhesive that will adhere to the human skin when pressed down thereon. The bottom of layer B has a layer C which is of a less adhering quality when compared to the top layer A because it is coated with a release agent as will be explained below. The reason for this is that the protective sheets are presented to the public in stacks and are displayed in conspicuous places. It is up the person, who wants to use such a protective sheet, to merely press his or her hand on the top layer and the adhesive layer will readily adhere to that person's palm area while the sheet is releasing itself from the next layer there under. The same is true and will happen when one tries to adhere a protective layer to a bottom of a shoe.

The various layers will now be described in the order they appear in Fig.

A) is a silicone based medical grade adhesive that has proven itself and is known to be of hypo-allergenic qualities. It is known as a positive bio-material toxicology and user-friendly data. The PSA (Pressure Sensitive Adhesive) must also have low residual properties.
B) is a carrier plastic such as a polyethylene (PET) film or sheet. In most applications it must be resistant to oils, plasticizers, ultraviolet light (UV) and petroleum products.
C) The layer C contains a release agent that could be a chemical or polymer coating. The release agent is a layer that “lets go” of the protective hand or shoe sheet directly below it. However, it must be pressure sensitive providing package stability in a stack until it is ready for use by a consumer. It is obtainable as a “SPANJAARD” Air Drying Film. (ADF) The layer C could be a PTFE-based non-toxic dry lubricating film This film can be used in the food industry and is of a food grade. It is obtainable as a “SPANJAARD” Clear Dry Film (CDF). After all, the protective sheets could be used by food handlers that may occasionally touch raw food stuff. It is preferred that regular food handlers at Deli-counters, for example, wear complete protective gloves that surround a hand.

FIG. 2 illustrates a hand H having a protective sheet B applied to the palm side of the hand H. It is preferred that the outline of the sheet B be somewhat larger than the hand H and the fingers F to increase the protective qualities of the sheet B. This will also accommodate larger or smaller hands but will not interfere with the protection of the hand against dirt, bacterium, fumes or pungent smells once a sheet is applied to the palm of the user and the user touches something that may carry the above noted impurities. Such an occasion could be the use of the protective sheet while filling a gas tank of a car at a gas station. In this instance, a stack of the protective sheets would be located at the gasoline pump either on a side or on a top of the same. Since the protective sheets are adhering to each in a stack, they are readily available. Another location might be in a grocery store where a stack of protective sheets may be located at the entrance to the store where customers may grab a grocery cart. The handle of the grocery cart is being handled by so many people that may transfer impurities from their hands to the handle of the cart.

FIG. 3 is a cross section through a finger F illustrating where a protective sheet B, with its adhesive layer A, is just about being transferred to the finger F and being released from the next lower sheet B′.

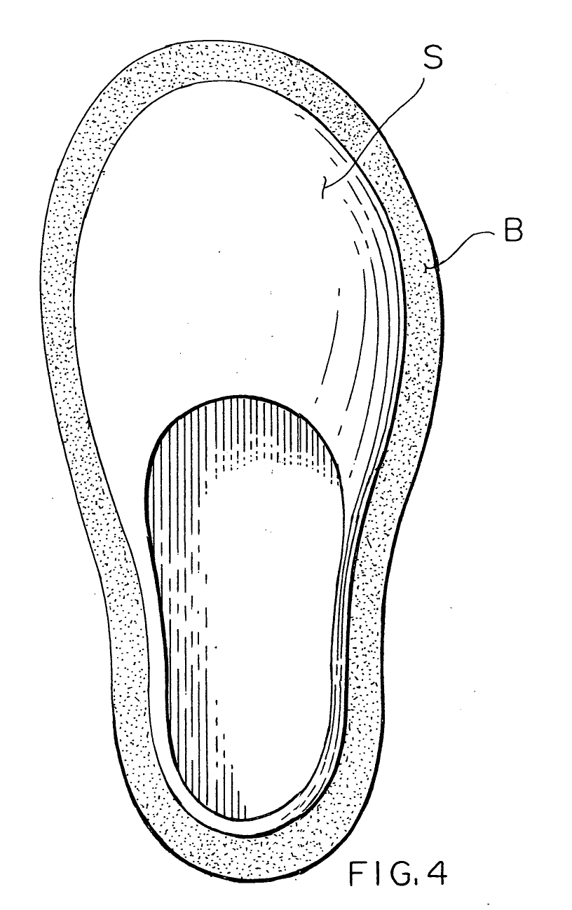

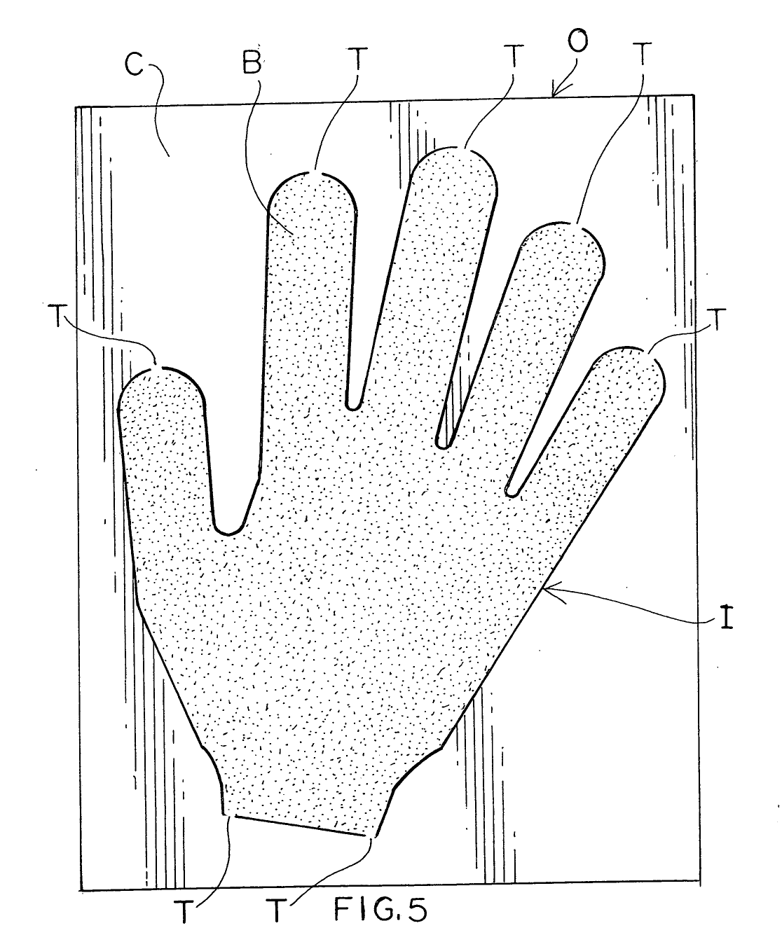

FIG. 4 illustrates the same principle of providing a protective sheet B to the bottom of a shoe S instead of a hand. Again, it is desirable that the outline of the protective sheet be somewhat larger than the shoe itself to accommodate different types and different sizes of shoes. A stack of these protective sheets could be placed at the entrance of a home when workmen are expected to a enter the home to repair or adjust various items. A stack of protective sheets could be placed at the entrance of a museum, for example, to protect the floor where most foot traffic would occur.

FIG. 5 illustrates a method of die cutting a stack of protective sheets. A is the top surface with the pressure sensitive adhesive thereon. B is the main protective sheet. C, the release agent cannot be seen in this top view. All of the prepared sheets are supplied in stack and then die cut into a rectangle by way of an outer cut O. After the outer cut O the outline of the protective hand sheet is cut by way of an inner cut I. The inner cut provides small tabs T at the fingertips and the wrist because the cutting tools has small voids at these locations. The reason for these small tabs is to impart integrity to the whole stack of sheets prior to being used. The initial outer die cut rectangle is placed into a container (box) and is being displayed at the point of intended use. When it is desired to use a protective sheet for a hand, for example, it is up to the user to place a hand on the top side of the next visible sheet and by way of a rolling motion from the wrist towards the fingers, the small tabs will break or tear and the sheet will adhere to the hand. The same principle is true when applied to a protective sheet for shoes, although not illustrated.

In view of all of the above, it can now be seen that the inventive stack of protective sheets could be placed in many locations to protect either a palm of a user or floors to be walked upon against contamination.

What I claim is:

1. A plurality of protective sheets adapted to be used individually from a stack of said protective sheets including a main sheet having an upper layer, said main layer having an upper adhesive layer thereon that will readily adhere to an item when pressed thereon, said main sheet having a lower layer thereon, said lower layer being a release agent to create a state of being of a less adhering power than said upper adhesive layer, whereby, when an item is pressed onto said upper adhesive layer, said upper layer will readily adhere to said item but will easily “let go” from the next protective sheet below in said stack of protective sheets without disturbing the remainder of said stack of said protective sheets.

2. The protective sheets of claim, wherein said item has the outline of a hand and the protective sheet will adhere to a palm of a hand of a user.

3. The protective sheets of claim 1, wherein said item has the outline of a bottom of a shoe of a user.

4. The protective sheets of claim 1, wherein an outline of said sheets is larger than the item being pressed thereon.

5. The protective sheets of claim 4 including small connecting tabs at predetermined location and at the outline of said sheets
